(19) United States
(12) Patent Application Publication
(10) Pub. No.: US 2026/0156709 A1
(43) Pub. Date: Jun. 4, 2026

(54) INFORMATION TRANSMISSION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Rao SHI, Beijing (CN); Yumin WU, Beijing (CN)

(21) Appl. No.: 18/716,777

(22) PCT Filed: Dec. 10, 2021
(86) PCT No.: PCT/CN2021/137232

§ 371 Date: Jun. 5, 2024

(51) Int. Cl. H04W 76/27

(52) U.S. Cl. CPC H04W 76/27

(57) ABSTRACT

An information transmission method is performed by a base station, and includes: sending indication information, wherein the indication information indicates a time threshold; wherein the time threshold is used for the user equipment UE to determine whether to verify Radio Resource Control rejection (RRCReject) message.

### CROSS REFERENCE TO RELATED APPLICATION

The present application is a U.S. National Stage of International Application No. PCT/CN2021/137232, filed on Dec. 10, 2021, the content of which is incorporated by reference herein in its entirety.

### TECHNICAL FIELD

The present disclosure relates to the field of wireless communication technology but is not limited to the field of wireless communication technology, and in particular, to information transmission method, apparatus, communication device and storage media.

### BACKGROUND

In a cellular mobile communication system, when the user equipment UE attempts to establish a Radio Resource Control (RRC) connection, the network can send a Radio Resource Control Reject (RRCReject) message through the Common Control Channel (CCCH) to reject the RRC connection process for UE. The RRCReject message has no security protection measures. When the UE receives the RRCReject message sent by the network, if there is a RejectwaitTime information element (IE), the UE will remain in the RRC non-connected state according to the IE, and will reinitiate the establishment or recovery the RRC connection until timeout.

### SUMMARY

In view of this, embodiments of the present disclosure provide an information transmission method, apparatus, communication device, and storage medium.

According to a first aspect of the embodiments of the present disclosure, there is provided an information transmission method, performed by a base station, including:
sending indication information, where the indication information indicates a time threshold; the time threshold is used for the user equipment (UE) to determine whether to verify RRCReject message.

According to a second aspect of the embodiments of the present disclosure, there is provided an information transmission method, performed by UE, including:
receiving indication information, where the indication information indicates a time threshold; the time threshold is used for the UE to determine whether to verify RRCReject message.

According to a third aspect of the embodiments of the present disclosure, there is provided an information transmission device, including:
a sending module configured to send indication information, where the indication information indicates a time threshold; the time threshold is used for the UE to determine whether to verify RRCReject message.

According to a fourth aspect of the embodiments of the present disclosure, there is provided an information transmission device, including:
a receiving module configured to receive indication information, where the indication information indicates a time threshold; the time threshold is used for the UE to determine whether to verify RRCReject message.

According to a fifth aspect of the embodiments of the present disclosure, there is provided a communication device, including a processor, a memory, and an executable program stored in the memory and capable of being run by the processor. When the processor runs the executable program, steps of the information transmission method according to the first aspect or the second aspect are performed.

According to a sixth aspect of the embodiments of the present disclosure, there is provided a storage medium with an executable program stored thereon. When the executable program is executed by a processor, steps of the information transmission method according to the first aspect or the second aspect are performed.

It should be understood that the above general description and the following detailed description are only exemplary and explanatory, and do not limit the embodiments of the present disclosure.

### BRIEF DESCRIPTION OF THE DRAWINGS

The accompanying drawings, which are incorporated in and constitute a part of this specification, illustrate embodiments consistent with the present disclosure and together with the description serve to explain the principles of the embodiments of the present disclosure.

FIG. 1 is a schematic structural diagram of a wireless communication system according to an embodiment;

FIG. 2 is a schematic flow chart of an information transmission method according to an embodiment;

FIG. 3 is a schematic flowchart of another information transmission method according to an embodiment;

FIG. 4 is a block diagram of an information transmission device according to an embodiment;

FIG. 5 is a block diagram of another information transmission device according to an embodiment;

FIG. 6 is a block diagram of a device for information transmission according to an embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of the present disclosure. Rather, they are merely examples of apparatus and methods consistent with aspects of embodiments of the present disclosure as detailed in the appended claims.

The terminology used in the embodiments of the present disclosure is for the purpose of describing specific embodiments only and is not intended to limit the embodiments of the present disclosure. As used in the embodiments of the present disclosure and the appended claims, the singular forms “a,” “the” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “as” or “in response to determining.”

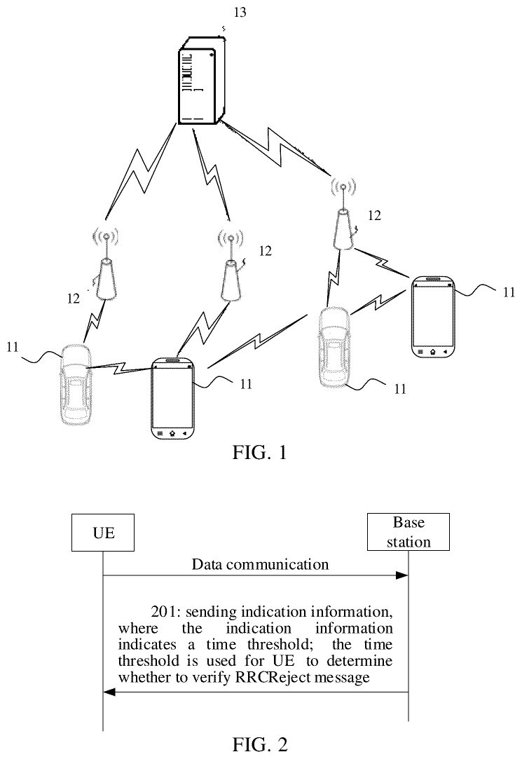

Please refer to FIG. 1, which shows a schematic structural diagram of a wireless communication system provided by an embodiment of the present disclosure. As shown in FIG. 1, the wireless communication system is a communication system based on cellular mobile communication technology. The wireless communication system may include several terminals 11 and several base stations 12.

The terminal 11 may be a device that provides voice and/or data connectivity to the user. The terminal 11 can communicate with one or more core networks via a Radio Access Network (RAN). The terminal 11 can be an Internet of Things terminal, such as a sensor device, a mobile phone (or a “cellular” phone) and a computer with the Internet of Things terminal, for example, it can be a fixed, portable, pocket-sized, handheld, computer-built-in or vehicle-mounted device. For example, station (STA), subscriber unit, subscriber station, mobile station, mobile, remote station, access point, remote terminal, access terminal, user terminal, user agent, user device, or user equipment (UE). Alternatively, the terminal 11 may be a device of an unmanned aerial vehicle. Alternatively, the terminal 11 may also be a vehicle-mounted device. For example, it may be an on-board computer with a wireless communication function, or a wireless communication device connected to an external on-board computer. Alternatively, the terminal 11 may also be a roadside device, for example, it may be a streetlight, a signal light or other roadside device with wireless communication function, etc.

The base station 12 may be a network-side device in a wireless communication system. The wireless communication system may be the 4th generation mobile communication technology (4G) system, also known as the Long Term Evolution (LTE) system; or the wireless communication system may also be a 5G system, also called new radio (NR) system or 5G NR system. Alternatively, the wireless communication system may also be a next-generation system of the 5G system. The access network in the 5G system can be called NG-RAN (New Generation-Radio Access Network), or MTC system.

The base station 12 may be an evolved base station (eNB) used in the 4G system. Alternatively, the base station 12 may also be a base station (gNB) that adopts a centralized distributed architecture in the 5G system. When the base station 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer. The distributed unit is provided with a physical (PHY) layer protocol stack, and the embodiment of the present disclosure does not limit the specific implementation of the base station 12.

A wireless connection can be established between the base station 12 and the terminal 11 through radio interface. In different implementations, the radio interface is a radio interface based on the fourth generation mobile communication network technology (4G) standard; or the radio interface is a radio interface based on the fifth generation mobile communication network technology (5G) standard, for example, the radio interface is a new radio; alternatively, the radio interface may also be a radio interface based on the next generation mobile communication network technology standard of 5G.

In some embodiments, an E2E (End to End) connection can also be established between terminals 11, for example, in the scenario such as V2V (vehicle to vehicle) communication, V2I (vehicle to Infrastructure) communication and V2P (vehicle to pedestrian) communication, etc. in vehicle to everything communication (V2X).

In some embodiments, the above-mentioned wireless communication system may also include a network management device 13.

Several base stations 12 are connected to the network management device 13 respectively. The network management device 13 may be a core network device in a wireless communication system. For example, the network management device 13 may be a mobility management entity (MME) in an evolved packet core network (EPC). Alternatively, the network management device can also be other core network devices, such as Serving GateWay (SGW), Public Data Network GateWay (PGW), Policy and Charging Rules function (PCRF) or Home Subscriber Server (HSS), etc. The embodiment of the present disclosure does not limit the implementation form of the network management device 13.

The execution entities involved in the embodiments of the present disclosure include but are not limited to: a UE such as a mobile phone terminal in the cellular mobile communication system, as well as a network-side device, such as an access network device like a base station, etc., and a core network.

Since the RRCReject message does not have any security protection mechanism, if an attacker launches an RRCReject message attack on the UE and arbitrarily tampers with the RejectwaitTime IE, the UE will suffer a Denial of Service (Dos) attack and be unable to enter the connected state to send and receive services.

Therefore, a field RejectMAC-I can be introduced in the RRCReject message for protection. The calculation of RejectMAC-I can be realized through a predetermined algorithm, such as the NIA algorithm and the following input parameters:
a) Key (KEY): K_{RRCint} stored in the current UE context;
b) Bearer (BEARER): bearer identification;
c) Direction (DIRECTION): data direction;
d) Count COUNT: current COUNT value;
e) Message (MESSAGE), including: source C-RNTI, source PCI, target Cell-ID, reply reason (resumeCause) and/or waiting time (waitTime).

When the UE receives the RRCReject message sent by the base station (such as gNB), it needs to verify the RejectMAC-I field in the RRCReject message according to the same algorithm. When the verification passes, the UE will receive the RRCReject message, thus effectively avoiding attackers from attacking the message.

However, the network does not need to have the RejectMAC-I function every time it sends an RRCReject message. Therefore, how to use RejectMAC-I flexibly to meet different security needs and improve compatibility is an issue that needs to be solved urgently.

As shown in FIG. 2, the embodiment provides an information transmission method that can be executed by the core network of the cellular mobile communication system, including:
Step 201: Sending indication information, where the indication information indicates a time threshold; the time threshold is used for the UE to determine whether to verify the RRCReject message.

Here, the RRCReject message is a message sent by the base station to reject the RRC connection process of the UE when the UE initiates the RRC connection. Here, the RRC connection initiated by the UE may include: RRC connection recovery by the inactive UE. The RRC connection initiated by the UE may also include: RRC connection establishment when the UE is idle or when the UE is activated for the first time, and RRC reconnection after connection failure.

Determining whether to verify the RRCReject message may include determining whether to verify the security of the RRCReject message.

For example, the message carrying the indication information is different from the RRCReject message.

For example, determining whether to verify the security of the RRCReject message includes: determining whether to verify the verification information carried in the RRCReject message, or verifying whether the waiting time carried in the RRCReject message is a duration that has not been tampered with.

The RRCReject message sent by the base station may or may not contain verification information. The verification information may include: security verification information and/or integrity verification information, etc. The verification information can be the field in the RRCReject message: RejectMAC-I. The determination method may be as described above and will not be repeated here. By verifying RejectMAC-I, it can be determined whether the RRCReject message has been tampered with, and the integrity of the RRCReject message can be determined, thereby improving the security of information transmission.

Verification of the RRCReject message may include verification of the verification information to determine the integrity of the RRCReject message, and/or the security of the RRCReject message, etc. Thereby, reception errors or unsafe situations caused by incomplete and/or tampered RRCReject messages are reduced.

The time threshold can be used for the UE to compare with the duration associated with the RRC connection. Whether to verify the RRCReject message is determined based on the comparison result. The predetermined duration may include but is not limited to: the waiting time (waitTime) indicated by the RRCReject message, the duration from RRC release to RRC connection recovery by the UE, etc. Here, the waiting time, that is, the rejection waiting time (RejectwaitTime), is the duration indicated by the base station that the UE is not allowed to perform RRC connection recovery.

In this way, the UE can determine whether to verify the RRCReject message based on the time threshold. Compared with not performing RRCReject message verification at all or verifying each RRCReject message, the flexibility of RRCReject message verification is improved and different security requirements for RRCReject messages are met.

In one embodiment, the effective area of the time threshold is:
a cell where the indication information is sent;
or,
an access network notification area RNA where the cell where the indication information is sent resides.

The time threshold may be effective in the cell where the indication information is sent. That is, after the UE receives the indication information in the current cell, the time threshold is configured to determine whether to verify the RRCReject message received by the current cell. Here, the cell where the indication information is sent refers to the cell where the base station sends the indication information. For example, if the base station sends an indication information in cell A, then the time threshold indicated by the indication information takes effect in cell A.

The access network notification area RNA may be an area covered by a signal of the access network. The time threshold may be effective in the RNA of the access network that sends the indication information. That is, after the UE receives the indication information, the time threshold is configured to determine whether to verify the RRCReject message received by the RNA of the access network.

In this way, through the time threshold, the UE can determine whether to verify the RRCReject message in the effective area to meet the RRCReject message verification requirements in different areas.

In one embodiment, the indication information is carried in at least one of the following messages:
Radio Resource Control Release RRCRelease message;
or,
system message.

The base station sends indication information indicating the time threshold to the UE through the RRCRelease message. The time threshold can take effect in the cell where the RRCRelease message is sent, or in the RNA of the access network where the RRCRelease message is sent.

For example, the time threshold indicated by the indication information carried in the RRCRelease message takes effect in RNA: the base station sends the time threshold to the UE through the RRCRelease message and the time threshold takes effect in the entire RNA area. The time threshold is configured to determine whether to verify RejectMAC-I message when the UE receives the RRCReject message.

For example, the time threshold indicated by the indication information carried in the RRCRelease message takes effect in RNA: the UE receives the time threshold in the RRCRelease message of the anchor base station, but moves to other cell (belonging to the same RNA) in the non-connected state to initiate the RRC Connection Recovery. At this time, the time threshold currently stored by the UE can be applied to the cell that initiates the RRC Connection Recovery. Here, the anchor base station is the base station where the UE is released from the RRC connected state to the RRC idle state/RRC inactive state.

The base station sends indication information indicating the time threshold to the UE through the system message. The time threshold can take effect in the cell where the system message is sent, or in the RNA of the access network where the system message is sent. Here, the system message may include a system message block (SIB), and the indication information may be carried in the existing SIB, or a new SIB may be added to carry the indication information.

For example, the time threshold indicated by the indication information carried in the system message takes effect in the cell where the system message is sent: the base station sends the time threshold to the UE through system message broadcast, and the time threshold takes effect in the current cell, for the UE to determine whether RejectMAC-I needs to be verified when receiving the RRCReject message.

For example, the time threshold indicated by the indication information carried in the system message takes effect in the RNA where the system message is sent: the base station sends the time threshold to the UE through system message broadcast, and the time threshold takes effect in the entire RNA area, for the UE to determine whether the RejectMAC-I message needs to be verified when receiving the RRCReject message. Alternatively, all base stations under RNA broadcast the same time threshold, and no matter whether the UE is in the anchor cell or moves to a new cell, the same time threshold is used to determine the verification of the RRCReject message.

In one embodiment, the waiting time indicated by the RRCReject message is less than the time threshold, and the RRCReject message does not include verification information.

The waiting time indicated by the RRCReject message is greater than or equal to the time threshold, and the RRCReject message includes the verification information.

The time threshold can be set based on the security of the RRCReject message. If the waiting time indicated by the RRCReject message is less than the time threshold, for example, the waiting time is 1 second or 2 seconds, etc., then the RRCReject message is unlikely to be tampered with during this time period. Therefore, no verification information can be set in the RRCReject message. The UE does not need to perform verification after receiving the RRCReject message.

For example, if the waiting time that the base station currently wants to send is less than the currently configured time threshold, it does not need to use the RejectMAC-I function and the base station directly sends the RRCReject message without RejectMAC-I to the UE, that is, there is no authentication mechanism.

For example, when the UE receives the time threshold from the system message broadcast of the current base station and receives the RRCReject message in the RRC Connection Recovery process, if the waiting time is not configured, or the waiting time is less than the time threshold, then the verification process is ignored.

For example, when the UE receives the time threshold from the RRCRelease message of the anchor base station and receives the RRCReject message in the RRC connection recovery process sent by the cell under the entire RNA, if the waiting time is not configured, or the waiting time is less than the time threshold, then the verification process is ignored.

If the waiting time indicated by the RRCReject message is greater than or equal to the time threshold, then there is a possibility that the RRCReject message has been tampered with during this time period. Therefore, verification information can be set in the RRCReject message. The UE needs to perform verification after receiving the RRCReject message.

For example, if the waiting time that the base station currently wants to send is greater than or equal to the currently configured time threshold, it needs to use the RejectMAC-I function and the base station sends an RRCReject message carrying RejectMAC-I to the UE for the UE to authenticate the message.

For example, when the UE receives the time threshold from the system message broadcast of the current base station and receives the RRCReject message in the RRC connection recovery process, if the configured waiting time is greater than or equal to the time threshold, it needs to verify based on the RejectMAC-I carried in the message.

For example, when the UE receives the time threshold from the RRCRelease message of the anchor base station and receives the RRCReject message in the RRC connection recovery process sent by the cell under the entire RNA, if the configured waiting time is greater than or equal to the time threshold, then it needs to verify based on the RejectMAC-I carried in the message.

The indication information is carried in the system message.

In one embodiment, before sending the indication information, the method further includes:
determining whether to send the indication information at least based on the time threshold.

Sending indication information includes:
sending the indication information in response to the time threshold being configured.

The base station can determine whether to send the indication information based on whether the time threshold is configured.

If a time threshold is configured, the base station can send indication information to the UE, and determine whether to carry verification information, that is, RejectMAC-I, in the RRCReject message based on the comparison result between the time threshold and the waiting time.

In one embodiment, determining whether to send the indication information at least based on the time threshold includes:
in response to the time threshold not being configured, the base station does not need to send the indication information.

In one embodiment, in response to determining not to send the indication information, the RRCReject message does not include verification information.

In one embodiment, in response to the RRCReject message not indicating a waiting time, the RRCReject message does not include verification information.

If the base station does not configure a time threshold, or the base station does not configure a waiting time, then the base station does not need to carry the security verification message when sending the RRCReject message. After receiving the RRCReject message, the UE does not perform verification.

For example, if the base station does not currently configure a time threshold, for example, the base station does not configure a time threshold for any UE by using the RRCRelease message, or the base station does not broadcast the time threshold, then there is no need to use the RejectMAC-I function. When the current UE does not receive the time threshold sent by the base station through the broadcasted system message or the RRCRelease message, the verification process is ignored.

In one embodiment, the method further includes:
in response to successful verification of the RRCReject message, the UE does not initiate RRC connection recovery within the waiting time.

If the UE successfully verifies the RRCReject message, for example, the UE successfully verifies the RejectMAC-I, it directly uses the waiting time to respond to the duration of Denial of Service for the RRCReject message. Within this waiting time, RRC connection recovery will not be initiated. The UE can initiate RRC connection recovery after the waiting time.

In one embodiment, the method further includes:
in response to failed verification of the RRCReject message, the UE ignores the RRCReject message.

If the UE fails to verify the RRCReject message, for example, the UE fails to verify the RejectMAC-I of the RRCReject message, then it can be determined that the RRCReject message has been tampered with or damaged. In this case, the RRCReject message can be ignored, that is, it is considered that no message has been received from the base station until T319 timer expires, and the UE determines that recovery failed.

In one embodiment, the method further includes:
in response to not verifying the RRCReject message, the UE does not initiate RRC connection recovery within the waiting time.

If the UE ignores the verification process, that is, the UE does not verify the RRCReject message, the UE can directly use the waiting time in the RRCReject message to respond to the duration of Denial of Service for the RRCReject message. During the waiting time, RRC connection recovery will not be initiated. RRC connection will be initiated after the waiting time. The UE can initiate RRC connection recovery after the waiting time.

In practical applications, the pseudo base station modifies the waiting time in the RRCReject message. Usually, the modified waiting time is smaller than the waiting time before modification. If the waiting time in the predefined RRCReject message is greater than the time threshold, then when the UE receives the RRCReject message, it compares the waiting time with the time threshold, and can initially determine whether the waiting time has been modified. If the waiting time is less than the time threshold, it can be determined that the waiting time has been modified. That is, the time threshold is also a verification mechanism.

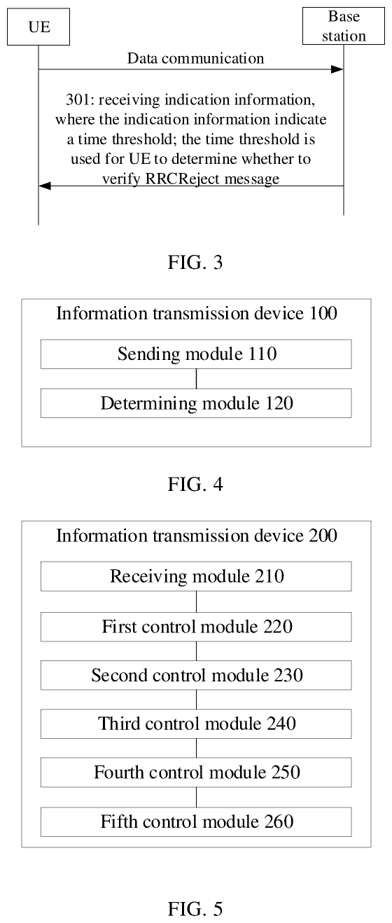

As shown in FIG. 3, the embodiment provides an information transmission method that can be executed by a UE in a cellular mobile communication system, including:
Step 301: receiving indication information, where the indication information indicates a time threshold; the time threshold is used for the UE to determine whether to verify the RRCReject message.

Here, the RRCReject message is a message sent by the base station to reject the RRC connection process of the UE when the UE initiates the RRC connection. Here, the RRC connection initiated by the UE may include: RRC connection recovery by the inactive UE. The RRC connection initiated by the UE may also include: RRC connection establishment when the UE is idle or when the UE is activated for the first time, and RRC reconnection after connection failure.

Determining whether to verify the RRCReject message may include determining whether to verify the security of the RRCReject message. The message carrying the indication information may be different from the RRCReject message.

For example, determining whether to verify the security of the RRCReject message includes: determining whether to verify the verification information carried in the RRCReject message, or verifying whether the waiting time carried in the RRCReject message is a time period that has not been tampered with.

The RRCReject message sent by the base station may or may not contain verification information. The verification information may include: security verification information and/or integrity verification information, etc. The verification information can be the field in the RRCReject message: RejectMAC-I. The determination method may be as described above and will not be repeated here. By verifying RejectMAC-I, it can be determined whether the RRCReject message has been tampered with, and the integrity of the RRCReject message can be determined, thereby improving the security of information transmission.

Verification of the RRCReject message may include verification of the verification information to determine the integrity of the RRCReject message, and/or the security of the RRCReject message, etc. Thereby, reception errors or unsafe situations caused by incomplete and/or tampered RRCReject messages are reduced.

The time threshold can be used for the UE to compare with the duration associated with the RRC connection. Whether to verify the RRCReject message is determined based on the comparison result. The predetermined duration may include but is not limited to: the waiting time (waitTime) indicated by the RRCReject message, the duration from RRC release to RRC connection recovery by the UE, etc. Here, the waiting time is the duration indicated by the base station that the UE is not allowed to perform RRC connection recovery.

In this way, the UE can determine whether to verify the RRCReject message based on the time threshold. Compared with not performing RRCReject message verification at all or verifying each RRCReject message, the flexibility of RRCReject message verification is improved and different security requirements for RRCReject messages are met.

In one embodiment, the effective area of the time threshold is:
a cell where the indication information is sent;
or,
an access network notification area RNA where the cell where the indication information is sent resides.

The time threshold may be effective in the cell where the indication information is sent. That is, after the UE receives the indication information in the current cell, the time threshold is configured to determine whether to verify the RRCReject message received by the current cell. Here, the cell where the indication information is sent refers to the cell where the base station sends the indication information. For example, if the base station sends an indication information in cell A, then the time threshold indicated in the indication information takes effect in cell A.

The access network notification area RNA may be an area covered by a signal of the access network. The time threshold may be effective in the RNA of the access network that sends the indication information. That is, after the UE receives the indication information, the time threshold is configured to determine whether to verify the RRCReject message received by the RNA of the access network.

In this way, through the time threshold, the UE can determine whether to verify the RRCReject message in the effective area to meet the RRCReject message verification requirements in different areas.

In one embodiment, the indication information is carried in at least one of the following messages:
Radio Resource Control Release RRCRelease message;
or,
system message.

The base station sends indication information indicating the time threshold to the UE through the RRCRelease message. The time threshold can take effect in the cell where the RRCRelease message is sent, or in the RNA of the access network where the RRCRelease message is sent.

For example, the time threshold indicated by the indication information carried in the RRCRelease message takes effect in RNA: the base station sends the time threshold to the UE through the RRCRelease message and the time threshold takes effect in the entire RNA area. The time threshold is configured to determine whether to verify RejectMAC-I message when the UE receives the RRCReject message.

For example, the time threshold indicated by the indication information carried in the RRCRelease message takes effect in RNA: the UE receives the time threshold in the RRCRelease message of the anchor base station, but moves to other cell (belonging to the same RNA) in the non-connected state to initiate The RRC connection recovery. At this time, the time threshold currently stored by the UE can be applied to the cell that initiated the RRC connection recovery. Here, the anchor base station is the base station where the UE is released from the RRC connected state to the RRC idle state/RRC inactive state.

The base station sends indication information indicating the time threshold to the UE through the system message. The time threshold can take effect in the cell where the system message is sent, or in the RNA of the access network where the system message is sent. Here, the system message may include a system message block (SIB), and the indication information may be carried in the existing SIB, or a new SIB may be added to carry the indication information.

For example, the time threshold indicated by the indication information carried in the system message takes effect in the cell where the system message is sent: the base station sends the time threshold to the UE through system message broadcast, and the time threshold takes effect in the current cell, for the UE to determine whether RejectMAC-I needs to be verified when receiving the RRCReject message.

For example, the time threshold indicated by the indication information carried in the system message takes effect in the RNA where the system message is sent: the base station sends the time threshold to the UE through system message broadcast, and the time threshold takes effect in the entire RNA area, for the UE to determine whether the RejectMAC-I message needs to be verified when receiving the RRCReject message. Alternatively, all base stations under RNA broadcast the same time threshold, and no matter whether the UE is in the anchor cell or moves to a new cell, the same time threshold is used to determine the verification of the RRCReject message.

In one embodiment, determining whether to verify the RRCReject message includes:
in response to the waiting time indicated by the RRCReject message being less than the time threshold, determining not to verify the RRCReject message;
or,
in response to the waiting time indicated by the RRCReject message being greater than or equal to the time threshold, determining to verify the RRCReject message.

The time threshold can be set based on the security of the RRCReject message. If the waiting time indicated by the RRCReject message is less than the time threshold, for example, the waiting time is 1 second or 2 seconds, etc., then the RRCReject message is unlikely to be tampered with during this time period. Therefore, no verification information can be set in the RRCReject message. The UE does not need to perform verification after receiving the RRCReject message.

For example, if the waiting time that the base station currently wants to send is less than the currently configured time threshold, it does not need to use the RejectMAC-I function and the base station directly sends the RRCReject message without RejectMAC-I to the UE, that is, there is no authentication mechanism.

For example, when the UE receives the time threshold from the system message broadcast of the current base station and receives the RRCReject message in the RRC connection recovery process, if the waiting time is not configured, or the waiting time is less than the time threshold, then the verification process is ignored.

For example, when the UE receives the time threshold from the RRCRelease message of the anchor base station and receives the RRCReject message in the RRC connection recovery process sent by the cell under the entire RNA, if the waiting time is not configured, or the waiting time is less than the time threshold, then the verification process is ignored.

If the waiting time indicated by the RRCReject message is greater than or equal to the time threshold, then there is a possibility that the RRCReject message has been tampered with during this time period. Therefore, verification information can be set in the RRCReject message. The UE needs to perform verification after receiving the RRCReject message.

For example, if the waiting time that the base station currently wants to send is greater than or equal to the currently configured time threshold, it needs to use the RejectMAC-I function and the base station sends an RRCReject message carrying RejectMAC-I to the UE for the UE to authenticate the message.

For example, when the UE receives the time threshold from the system message broadcast of the current base station and receives the RRCReject message in the RRC connection recovery process, if the configured waiting time is greater than or equal to the time threshold, it needs to verify based on the RejectMAC-I carried in the message.

For example, when the UE receives the time threshold from the RRCRelease message of the anchor base station and receives the RRCReject message in the RRC connection recovery process sent by the cell under the entire RNA, if the configured waiting time is greater than or equal to the time threshold, then it needs to verify based on the RejectMAC-I carried in the message.

In one embodiment, the method further includes:
in response to not receiving the indication information, not verifying the RRCReject message;
or,
in response to the RRCReject message not indicating the waiting time, not verifying the RRCReject message.

If the base station does not configure a time threshold, or the base station does not configure a waiting time, then the base station does not need to carry the security verification message when sending the RRCReject message. After receiving the RRCReject message, the UE does not perform verification.

For example, if the base station does not currently configure a time threshold, for example, the base station does not configure a time threshold for any UE by using the RRCRelease message, or the base station does not broadcast the time threshold, then there is no need to use the RejectMAC-I function. When the current UE does not receive the time threshold sent by the base station through the broadcasted system message or the RRCRelease message, the verification process is ignored.

In one embodiment, the method further includes:
in response to successful verification of the RRCReject message, not initiating RRC connection recovery within the waiting time.

If the UE successfully verifies the RRCReject message, for example, the UE successfully verifies the RejectMAC-I, it directly uses the waiting time to respond to the duration of Denial of Service for the RRCReject message. Within this waiting time, RRC connection recovery will not be initiated. The UE can initiate RRC connection recovery after waiting time.

In one embodiment, the method further includes:
in response to failure verification of the RRCReject message, ignoring the RRCReject message.

If the UE fails to verify the RRCReject message, for example, the UE fails to verify the RejectMAC-I of the RRCReject message, then it can be determined that the RRCReject message has been tampered with or damaged. In this case, the RRCReject message can be ignored, that is, it is considered that no message has been received from the base station until T319 timer expires, and the UE determines that recovery failed.

In one embodiment, the method further includes:
in response to not verifying the RRCReject message, not initiating RRC connection recovery within the waiting time.

If the UE ignores the verification process, that is, the UE does not verify the RRCReject message, the UE can directly use the waiting time in the RRCReject message to respond to the duration of Denial of Service for the RRCReject message. During the waiting time, RRC connection recovery will not be initiated. RRC connection will be initiated after the waiting time. The UE can initiate RRC connection recovery after waiting time.

A specific example is provided below in combination with any of the above embodiments:
1. The base station sends the time threshold (threshold) used to limit the waiting time (waitTime) in the Radio Resource Control Reject (RRCReject) message to the UE through the following message:
   a. Radio Resource Control Release (RRCRelease) message;
   b. System message (SystemInfo).

Embodiment a: The base station sends the time threshold to the UE through the RRCRelease message, and the time threshold takes effect in the entire RNA area, and is used by the UE to determine whether it needs to verify the RejectMAC-I when receiving the RRCReject message.

Embodiment b: The base station sends the time threshold to the UE through system message broadcast (SIBx, which can be an existing SIB or a new SIB), and the time threshold takes effect in the entire RNA area. The time threshold is used to determine whether RejectMAC-I needs to be verified when the UE receives the RRCReject message.

Embodiment c: The base station sends a time threshold to the UE through system message broadcast (SIBx, which can be an existing SIB or a new SIB), and the time threshold takes effect in the current cell. The time threshold is used to determine whether RejectMAC-I needs to be verified when the UE receives the RRCReject message. That is, if the UE moves to another cell, the time threshold broadcast by another cell is used.
2. The time threshold configured by the current base station takes effect in the entire RNA area.

Embodiment a: The UE receives the time threshold in the RRCRelease message of the anchor base station, but moves to another cell (belonging to the same RNA) in the non-connected state and initiates RRC connection recovery. At this time, the time threshold received and stored by the UE in the anchor base station may be applied to the cell that newly initiate connection recovery.

Embodiment b: All base stations under RNA broadcast the same time threshold. No matter whether the UE is in the anchor cell or moves to a new cell, the same time threshold is used to determine the verification of the RRCReject message. The anchor base station is the base station where the UE is released from the connected state to the idle state/inactive state, that is, the last serving cell.
3. The base station sends the RRCReject message (carrying RejectMAC-I) to the UE according to the configured time threshold.

Embodiment a: If the waiting time that the base station currently wants to send is less than the currently configured time threshold, there is no need to use the RejectMAC-I function and the base station directly sends the RRCReject message without RejectMAC-I to the UE, that is, there is no authentication mechanism.

Embodiment b: If the waiting time that the base station currently wants to send is greater than or equal to the currently configured time threshold, it needs to use the RejectMAC-I function to send an RRCReject message carrying RejectMAC-I to the UE for the UE to authenticate the message.

Embodiment c: If the base station does not currently configure a time threshold, for example, the base station does not configure a time threshold for any UE by using the RRCRelease message, or the base station does not broadcast the time threshold, then there is no need to use the RejectMAC-I function.

### Terminal Side

1. The UE determines whether the waiting time in the RRCReject message needs to be verified based on whether the base station configures a time threshold.

Embodiment a: When the UE receives the time threshold from the system message broadcast of the current base station and receives the RRCReject message in the RRC connection recovery process, if the waiting time is not configured, or the waiting time is less than the time threshold, then the verification process is ignored.

Embodiment b: When the UE receives the time threshold from the system message broadcast of the current base station and receives the RRCReject message in the RRC connection recovery process, if the configured waiting time is greater than or equal to the time threshold, it needs to verify based on RejectMAC-I carried in the message.

For the system message broadcast method, the time threshold can be effective in the entire RNA area or can be not effective in the entire RNA area. The UE can always verify according to the time threshold broadcasted by system message of the current resident cell.

Embodiment c: Scenario where the time threshold takes effect in the entire RNA area. When the UE receives the time threshold from the RRCRelease message of the anchor base station, and when it receives the RRCReject message in the RRC connection recovery process sent by the cell under the entire RNA, if the waiting time is not configured, or the waiting time is less than the time threshold, then the verification process is ignored.

Embodiment d: Scenario where the time threshold takes effect in the entire RNA area. When the UE receives the time threshold in the RRCRelease message from the anchor base station, and when it receives the RRCReject message in the RRC connection recovery process sent by the cell under the entire RNA, if the configured waiting time is greater than or equal to the time threshold, it needs to verify based on the RejectMAC-I carried in the message.

Embodiment e: If the current UE does not receive the time threshold sent by the base station (broadcast or RRCRelease), the verification process is ignored.
2. The UE responds to whether to receive the RRCReject message based on the verification result of the RejectMAC-I.

Embodiment a: If the UE fails to verify the RejectMAC-I, it ignores the RRCReject message, that is, it considers that it has not received any message from the base station. At this time, when T319 timer expires, the UE considers the recovery failed.

Embodiment b: According to embodiments a/c/e of claim 1, if the UE ignores the verification process, it directly uses the waiting time to respond to the duration of Denial of Service for the RRCReject message. Within the waiting time, no secondary RRC connection recovery will be initiated.

Embodiment c: If the UE successfully verifies the RejectMAC-I, it directly uses the waiting time to respond to the duration of Denial of Service for the RRCReject message. Within the waiting time, no secondary RRC connection recovery will be initiated.

The embodiment of the present disclosure also provides an information transmission device, as shown in FIG. 4, applied in a base station for cellular mobile wireless communication. The device 100 includes:
a sending module 110 configured to send indication information, where the indication information indicates a time threshold; the time threshold is used for the UE to determine whether to verify the RRCReject message.

In one embodiment, the effective area of the time threshold is:
a cell where the indication information is sent;
or,
an access network notification area RNA where the cell where the indication information is sent resides.

In one embodiment, the waiting time indicated by the RRCReject message is less than the time threshold, and the RRCReject message does not include verification information.

The waiting time indicated by the RRCReject message is greater than or equal to the time threshold, and the RRCReject message includes the verification information.

In one embodiment, the indication information is carried in at least one of the following messages:
Radio Resource Control Release RRCRelease message;
or,
system message.

In one embodiment, the device further includes:
a determining module 120 configured to determine whether to send the indication information at least based on the time threshold before sending the indication information.

The sending module 110 is specifically configured to send the indication information in response to the time threshold being configured.

In one embodiment, the determining module 120 is specifically configured to determine not to send the indication information in response to the time threshold not being configured.

In one embodiment, in response to determining not to send the indication information, the RRCReject message does not include verification information.

In one embodiment, in response to the RRCReject message not indicating a waiting time, the RRCReject message does not include verification information.

The embodiment of the present disclosure also provides an information transmission device, as shown in FIG. 5, applied to UE for cellular mobile wireless communication. The device 200 includes:
a receiving module 210 configured to receive indication information, where the indication information indicates a time threshold; the time threshold is used for the UE to determine whether to verify the RRCReject message.

In one embodiment, the effective area of the time threshold is:
a cell where the indication information is sent;
or,
an access network notification area RAN where the cell where the indication information is sent resides.

In one embodiment, the receiving module 210 is specifically configured to:
in response to the waiting time indicated by the RRCReject message being less than the time threshold, determine not to verify the RRCReject message;
or,
in response to the waiting time indicated by the RRCReject message being greater than or equal to the time threshold, determine to verify the RRCReject message.

In one embodiment, the device further includes:
a first control module 220 configured to, in response to successful verification of the RRCReject message, not initiate RRC connection recovery within the waiting time.

In one embodiment, the device further includes:
a second control module 230 configured to ignore the RRCReject message in response to failed verification of the RRCReject message.

In one embodiment, the device further includes:
a third control module 240 configured to not initiate RRC connection recovery within the waiting time in response to not verifying the RRCReject message.

In one embodiment, the receiving module 210 is specifically configured to:
determine whether to verify the verification information carried in the RRCReject message.

In one embodiment, the indication information is carried in at least one of the following messages:
Radio Resource Control Release RRCRelease message;
or,
system message.

In one embodiment, the device further includes:
a fourth control module 250 configured to not verify the RRCReject message in response to not receiving the indication information;
or,
a fifth control module 260 configured to not verify the RRCReject message in response to the RRCReject message not indicating waiting time.

In an embodiment, the sending module 110, the determining module 120, the receiving module 210, the first control module 220, the second control module 230, the third control module 240, the fourth control module 250 or the fifth control module 260 may be realized by one or more of central processing unit (CPU), graphics processor (GPU), baseband processor (BP), application specific integrated circuit (ASIC), DSP, Programmable Logic Device (PLD), Complex Programmable Logic Device (CPLD), Field-Programmable Gate Array (FPGA), general-purpose processor, controller, micro controller (MCU), microprocessor, or other electronic components for executing the aforementioned method.

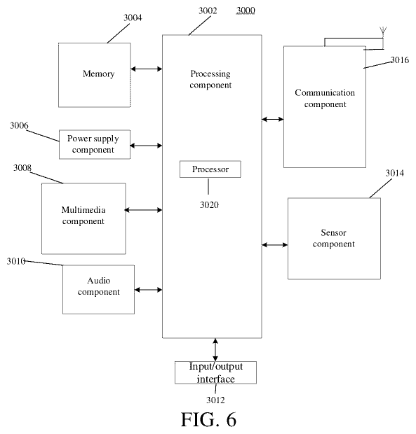

FIG. 6 is a block diagram of a device 3000 for information transmission according to an embodiment. For example, the device 3000 may be a mobile phone, a computer, a digital broadcast terminal, a messaging device, a game console, a tablet device, a medical device, a fitness device, a personal digital assistant, or the like.

Referring to FIG. 6, device 3000 may include one or more of the following components: processing component 3002, memory 3004, power supply component 3006, multimedia component 3008, audio component 3010, input/output (I/O) interface 3012, sensor component 3014, and communication component 3016.

The processing component 3002 generally controls the overall operations of the device 3000, such as operations associated with display, phone calls, data communications, camera operations, and recording operations. The processing component 3002 may include one or more processors 3020 to execute instructions to complete all or part of the steps of the above method. Additionally, the processing component 3002 may include one or more modules that facilitate interaction between the processing component 3002 and other components. For example, the processing component 3002 may include a multimedia module to facilitate interaction between the multimedia component 3008 and the processing component 3002.

The memory 3004 is configured to store various types of data to support operations at the device 3000. Examples of such data include instructions for any application or method operating on the device 3000, contact data, phonebook data, messages, pictures, videos, etc. The memory 3004 may be implemented by any type of volatile or non-volatile storage device, or a combination thereof, such as static random access memory (SRAM), electrically erasable programmable read-only memory (EEPROM), erasable programmable read-only memory (EPROM), Programmable read-only memory (PROM), read-only memory (ROM), magnetic memory, flash memory, magnetic or optical disk.

The power supply component 3006 provides power to the various components of the device 3000. The power supply components 3006 may include a power management system, one or more power supplies, and other components associated with generating, managing, and distributing power to the device 3000.

The multimedia component 3008 includes a screen that provides an output interface between the device 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. A touch sensor can not only sense the boundary of a touch or swipe action, but also detect the duration and pressure associated with the touch or swipe action. In some embodiments, the multimedia component 3008 includes a front camera and/or a rear camera. When the device 3000 is in an operating mode, such as a shooting mode or a video mode, the front camera and/or the rear camera may receive external multimedia data. Each of the front camera and the rear camera may be a fixed optical lens system or have focal length and optical zoom capabilities.

The audio component 3010 is configured to output and/or input audio signals. For example, the audio component 3010 includes a microphone (MIC) configured to receive external audio signals when the device 3000 is in operating modes, such as call mode, recording mode, and voice recognition mode. The received audio signals may be further stored in memory 3004 or sent via the communication component 3016. In some embodiments, the audio component 3010 also includes a speaker for outputting audio signals.

The I/O interface 3012 provides an interface between the processing component 3002 and a peripheral interface module. The peripheral interface module may be a keyboard, a click wheel, a button, etc. These buttons may include, but are not limited to: Home button, Volume buttons, Start button, and Lock button.

The sensor component 3014 includes one or more sensors that provide various aspects of status assessment for the device 3000. For example, the sensor component 3014 can detect the open/closed state of the device 3000, the relative positioning of components, such as the display and keypad of the device 3000. The sensor component 3014 can also detect the position change of the device 3000 or a component of the device 3000, presence or absence of contact of the user with the device 3000, orientation or acceleration/deceleration of the device 3000, and temperature changes of the device 3000. The sensor assembly 3014 may include a proximity sensor configured to detect the presence of nearby objects without any physical contact. The sensor assembly 3014 may also include a light sensor, such as a CMOS or CCD image sensor, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communication between the device 3000 and other devices. The device 3000 may access a wireless network based on a communication standard, such as Wi-Fi, 2G or 3G, or a combination thereof. In one embodiment, the communication component 3016 receives broadcast signals or broadcast related information from an external broadcast management system via a broadcast channel. In an embodiment, the communication component 3016 also includes a near field communications (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an embodiment, the device 3000 may be configured by one or more of application specific integrated circuit (ASIC), digital signal processor (DSP), digital signal processing device (DSPD), programmable logic device (PLD), field programmable Gate array (FPGA), controller, microcontroller, microprocessor or other electronic components for executing the above method.

In an embodiment, there is also provided a non-transitory computer-readable storage medium including instructions, such as a memory 3004 including instructions, which can be executed by the processor 3020 of the device 3000 to complete the above method. For example, the non-transitory computer-readable storage media may be ROM, random access memory (RAM), CD-ROM, magnetic tape, floppy disk, optical data storage device, etc.

Other implementations of the embodiments of the present disclosure will be readily apparent to those skilled in the art from consideration of the specification and practice of the disclosure disclosed herein. This application is intended to cover any variations, uses, or adaptations of the embodiments of the present disclosure that follow the general principles of the embodiments of the present disclosure and include common knowledge or common technical means in the technical field not disclosed by the embodiments of the present disclosure. It is intended that the specification and examples be considered as exemplary only, with a true scope and spirit of the embodiments of the present disclosure being indicated by the following claims.

It is to be understood that the embodiments of the present disclosure are not limited to the precise structures described above and illustrated in the accompanying drawings, and various modifications and changes may be made without departing from the scope thereof. The scope of embodiments of the present disclosure is limited only by the appended claims.

1. An information transmission method, performed by a base station, comprising:
sending indication information, wherein the indication information indicates a time threshold;
wherein the time threshold is used for the user equipment (UE) to determine whether to verify Radio Resource Control rejection (RRCReject) message.

2. The method according to claim 1, wherein an effective area of the time threshold is:
a cell where the indication information is sent; or an access network notification area (RNA) where a cell where the indication information is sent resides.

3. The method according to claim 1, wherein,
waiting time indicated by the RRCReject message is less than the time threshold, and the RRCReject message does not comprise verification information; and
waiting time indicated by the RRCReject message is greater than or equal to the time threshold, and the RRCReject message comprises the verification information.

4. The method according to claim 1 or 2, wherein the indication information is carried in at least one of the following messages:
a Radio Resource Control Release RRCRelease (RRCRelease) message; or
a system message.

5. The method according to claim 1, further comprising:
determining whether to send the indication information at least based on the time threshold; and
wherein sending the indication information comprises:
sending the indication information in response to the time threshold being configured.

6. The method according to claim 5, wherein determining whether to send the indication information at least based on the time threshold comprises:
determining not to send the indication information in response to the time threshold not being configured.

7. The method according to claim 6, wherein,
in response to determining not to send the indication information, the RRCReject message does not comprise verification information.

8. The method according to claim 1 or 2, wherein in response to the RRCReject message not indicating waiting time, the RRCReject message does not comprise verification information.

9. An information transmission method, performed by user equipment (UE), comprising:
receiving indication information, wherein the indication information indicates a time threshold; the time threshold is used for the UE to determine whether to verify Radio Resource Control Reject (RRCReject) message.

10. The method according to claim 9, wherein an effective area of the time threshold is:
a cell where the indication information is sent; or
an access network notification area (RAN) where the cell where the indication information is sent resides.

11. The method of claim 9, wherein determining whether to verify the RRCReject message comprises:
determining not to verify the RRCReject message in response to waiting time indicated by the RRCReject message being less than the time threshold; or
determining to verify the RRCReject message in response to waiting time indicated by the RRCReject message being greater than or equal to the time threshold.

12. The method according to claim 11, further comprising:
not initiating RRC connection recovery within the waiting period in response to a successful verification of the RRCReject message.

13. The method according to claim 11, further comprising:
ignoring the RRCReject message in response to a failed verification of the RRCReject message.

14. The method according to claim 11, further comprising:
not initiating RRC connection recovery within the waiting period in response to not verifying the RRCReject message.

15. The method according to claim 9, wherein determining whether to verify the RRCReject message comprises:
determining whether to verify verification information carried in the RRCReject message.

16. The method according to claim 9, wherein the indication information is carried in at least one of the following messages:
a Radio Resource Control Release (RRCRelease) message; or a system message.

17. The method according to claim 9, further comprising:
not verifying the RRCReject message in response to not receiving the indication information; or
not verifying the RRCReject message in response to the RRCReject message not indicating waiting time.

18.-34. (canceled)

35. A communication device, comprising:
a processor; and
a memory storing a program executable by the processor,
wherein the processor is configured to:
send indication information, wherein the indication information indicates a time threshold;
wherein the time threshold is used for the user equipment (UE) to determine whether to verify Radio Resource Control rejection (RRCReject) message.

36. A non-transitory storage medium with an executable program stored thereon, wherein when the executable program is executed by a processor, the processor is caused to perform the information transmission method according to claim 1.

37. A communication device, comprising:
a processor; and
a memory storing a program executable by the processor,
wherein the processor is configured to perform the information transmission method according to claim 9.
